(19) United States
(12) Patent Application Publication
(10) Pub. No.: US 2009/0166173 A1
(43) Pub. Date: Jul. 2, 2009

(54) Effluent gas recovery process for silicon production

(76) Inventor: Sarang GADRE, Bear, DE (US)

Correspondence Address: AIR LIQUIDE;Intellectual Property, 2700 POST OAK BOULEVARD, SUITE 1800, HOUSTON, TX, 77056, US

(21) Appl. No.: 12/059,676

(22) Filed: Mar. 31, 2008

Related U.S. Application Data
(63) Continuation-in-part of application No. 11/967,687, filed on Dec. 31, 2007.

(51) Int. Cl. B01D 3/14; B01D 53/047; B01D 3/34

(52) U.S. Cl. 203/32; 95/41; 202/183

(57) ABSTRACT

Purified SiHCl3 is used as a sweep gas across a permeate side of a gas separation membrane receiving effluent gas from a polysilicon reactor. The combined sweep gas and permeate is recycled to the reactor.

### CROSS-REFERENCE TO RELATED APPLICATIONS

This application is a Continuation-In-Part of U.S. patent application Ser. No. 11/967,687 filed on Dec. 31, 2007, the entire contents of which are incorporated herein by reference.

### BACKGROUND

Effluent gas recovery from silicon production process is important operation as it can reduce the cost of production. For a silicon production using Siemens method, effluent gas leaving the deposition reactor typically contains large quantities of hydrogen. This amount can vary based on set of operating conditions.

Some have proposed to recycle some of the hydrogen from the effluent gas using a gas separation membrane, such as disclosed by U.S. Pat. No. 4,941,893. However, such a solution comes with certain disadvantages.

When the deposition reactor is used for producing electronic grade polysilicon, it is typically operated at a pressure of about 5 psig. Hence, the product leaving the reactor does not offer much driving force for separation using gas separation membranes. So, in order to obtain a reasonable recovery, the effluent gas should be compressed prior to feeding it to the membrane. Hydrogen being the fast gas will be recovered in permeate stream operated at low pressure, for example, near deposition reactor pressure.

On the other hand, when the deposition reactor is used to produce solar grade polysilicon, it is typically operated at high pressure (>75 psig). This means that the effluent gas leaving the reactor is at a sufficiently high pressure to enable separation by gas separation membrane. The relatively low pressure permeate stream will need to be compressed to the deposition reactor pressure, thus adding to the compressor cost.

Thus, it is an object to propose a method and system for effluent gas recovery for polysilicon production that avoids the above described disadvantages.

### SUMMARY

There is disclosed a method for recycling effluent gas from a polysilicon production reactor that includes the following steps. An effluent gas from a polysilicon reactor is directed to a gas separation unit that comprises at least one gas separation membrane, wherein the effluent gas comprises SiHCl₃, SiCl₄, HCl, and H₂. A sweep gas comprising high purity SiHCl₃ is directed to a permeate side of the membrane. A recycle gas from the permeate side, wherein the recycle gas comprises H₂ permeated through the membrane from the effluent gas and SiHCl₃ from the sweep gas. The recycle gas is directed to the polysilicon reactor.

The disclosed method may include one or more of the following aspects:
the method further comprises the steps of:
   a retentate gas is recovered from the gas separation unit, the retentate gas comprising SiHCl₃, SiCl₄, HCl, and H₂;
   the retentate gas is directed to a SiHCl₃ production process; and
   purified SiHCl3 is obtained from the SiHCl3 production process, wherein the sweep gas comprises at least a portion of the obtained purified SiHCl3.
the recycle gas is not compressed before being directed to the polysilicon reactor.
the effluent gas is not compressed before being directed to the gas separation unit.
at least 50% of H2 in the effluent gas permeates to the permeate side.
at least 90% of H2 in the effluent gas permeates to the permeate side.
the SiHCl3 production process comprises the steps of:
   the retentate gas is chilled to produce a first condensate and a first non-condensate, the first condensate comprising predominantly SiHCl3 and SiCl4, the first non-condensate comprising a major amount of H2, a minor amount of chlorosilanes comprising SiHCl3, SiCl4, and a minor amount of HCl;
   the first non-condensate is directed to an adsorption unit wherein the major amount of H2 is stripped and the minor amount of HCl is separated from the minor amount of chlorosilanes;
   the first condensate and the chlorosilanes are directed to a distillation unit comprising at least one distillation column; and
   the purified SiHCl3 is produced at the distillation unit.
the SiHCl3 production process further comprises the steps of:
   Si and the HCl separated from the chlorosilanes are fed to a first SiHCl3 reactor thereby producing impure SiHCl3;
   the impure SiHCl3 is purified at a purification unit to produce a SiHCl3 feed;
   the SiHCl3 feed is directed to the distillation unit.
the SiHCl3 production process further comprises the steps of:
   SiCl4 from the distillation unit, Si, and H2 are fed to a second SiHCl3 reactor in the presence of CuCl thereby producing impure SiHCl3; and
   the impure SiHCl3 from the second SiHCl3 reactor is purified at purification unit.

There is also disclosed a system for recycling effluent gas from a polysilicon production reactor that comprises: a gas separation unit and a SiHCl3 production unit adapted and configured to produce purified SiHCl3. The gas separation unit comprises at least one gas separation membrane, an inlet, a permeate outlet, and a retentate outlet, wherein the inlet is adapted and configured to fluidly communicate with an effluent gas outlet of a polysilicon reactor and the permeate outlet is adapted and configured to fluidly communicate with a reactant feed inlet of the polysilicon reactor. The SiHCl3 production unit comprises an inlet in fluid communication with the retentate outlet and an outlet in fluid communication with a permeate side of the membrane.

The disclosed system may include one or more of the following aspects:
the membrane has a higher permeability to H2 than SiHCl3, HCl, and SiCl4.
there is no compressor in between the permeate outlet and the reactant feed inlet.
there is no compressor in between the effluent gas outlet and the membrane inlet.
the system further comprises:
   a first condensation unit having an inlet, a condensate outlet, and a vapor outlet, the condensation inlet being in fluid communication with the retentate outlet;
   an adsorption unit adapted and configured to strip H2 from a SiCl4, SiHCl3, HCl, and H2 containing vapor from the vapor outlet of the condensation unit and separate the remaining SiCl4, SiHCl3, and HCl into HCl and chlorosilanes comprising the remaining SiCl4 and SiHCl3; and
   a distillation unit having inlets in fluid communication with the first condensation unit outlet and the adsorption unit and having a purified SiHCl3 outlet in fluid communication with the inlet of the membrane.
the first condensation unit comprises first and second condensers connected in series and separated by a compressor.
the system further comprises:
   a first SiHCl3 reactor having reactant inlets in fluid communication with a source of Si and the adsorption unit;
   a purification unit having an inlet and outlet, the purification unit inlet being in fluid communication with an outlet of the first SiHCl3 reactor, the purification unit inlet being adapted and configured to receive impure SiHCl3 from the first SiHCl3 reactor, the purification unit outlet being in fluid communication with an inlet of the distillation unit.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a schematic of an embodiment of the system and method of the invention.

FIG. 2 is a schematic of another embodiment of the system and method of the invention.

### DESCRIPTION OF PREFERRED EMBODIMENTS

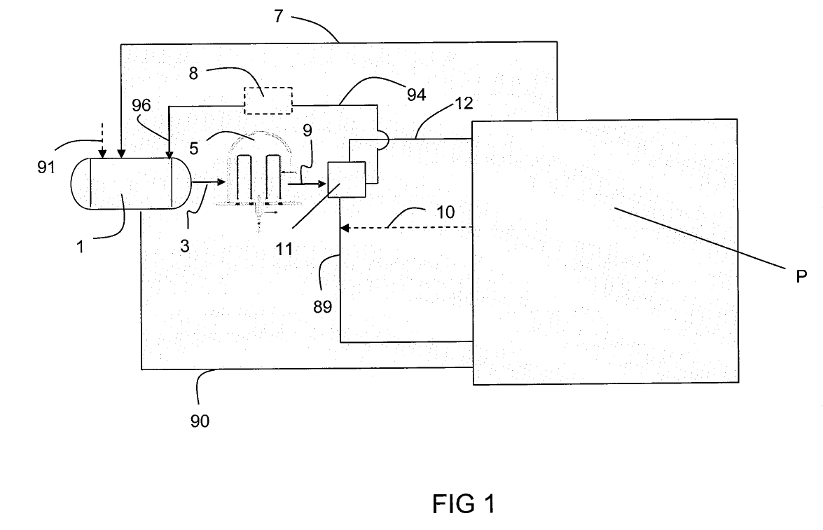

As best shown in FIG. 1, in one embodiment a trichlorosilane (TCS) and H2 feed 3 from feedstock tank 1 are fed to polysilicon reactor 5 where they react according to the below reaction:

SiHCl₃+H₂→Si+3HCl

The following equilibrium reactions also play a role:

2 SiHCl₃←→Si+SiCl₄+2HCl (1050-1200° C.)

4 SiHCl₃←→3SiCl₄+2H₂+Si

SiHCl₃+HCl←→SiCl₄+H₂

TCS is also in equilibrium with SiCl₂, a key intermediate:

SiHCl₃←→SiCl₂+HCl

While the schematic crudely depicts a bell jar shape, the invention is equally applicable to Siemens-type bell jar reactors and fluidized bed reactors. A wall temperature of the reactor is maintained at a temperature of about 575° C. and a deposition temperature is maintained at a temperature of about 1125° C. One of ordinary skill in the art will recognize that the TCS and H2 need not be fed to reactor from a feedstock tank 1. Rather, each of the reactants may be fed directly to reactor 5 without the intermediary feedstock tank 1. If the reactor 5 is being used to make electronic grade polysilicon, it is typically operated at a pressure of about 5 psig. In the case of solar grade polysilicon, it is operated at a pressure of 75 psig or greater.

Effluent gas stream 9 containing silicon tetrachloride (STC), an amount of non-reacted TCS, HCl, and H2 is directed to gas separation unit 11 where it is separated into a H₂-rich stream and a H₂-lean stream 12 containing TCS, STC, HCl, and a minor amount of H2. The gas separation unit 11 includes one or more gas separation membranes. The H2-lean stream 12 is directed to TCS purification system P which produces purified TCS stream 89, H2 stream 7, and optional H2 stream 10. All or part of the purified TCS for reaction in reactor 5 may be fed in stream 89 to the permeate “side” of the membrane where it acts as a sweep gas to lower the partial pressure of H2 permeating through the membrane from the effluent gas 9. One of ordinary skill in the art will recognize that the permeate “side” of a membrane does not necessarily mean one and only one side of a membrane. Rather, in the case of membranes include a plurality of hollow fibers, the permeate “side” actually is considered to be the plurality of sides of the individual hollow fibers that are opposite to the sides to which the effluent gas 9 is introduced.

Optionally and in order to reduce the tendency of TCS in stream 89 to condense, H2 stream 10 may be added to stream 89 to lessen such tendency. Also, one of ordinary skill in the art will recognize that any portion of purified TCS not directed to gas separation unit 11 may be directed to feedstock tank 1 instead.

The combined TCS sweep gas and H2-rich stream comprise the TCS/H2 recycle 94. Because the ratio of TCS to H2 in the combined recycle 94 and stream 7 may not be equivalent to the stoichiometric ratio desired for the reactor 5, one may optionally supplement the TCS and H2 in feedstock tank 1 with optional make up TCS and optional make up H2 91. Also, if the pressure of the recycle 94 is lower than that of the feedstock tank 1, an optional compressor 8 may be used to boost its pressure to the desired level.

Practice of the invention yields several benefits.

By using the purified TCS gas stream 89 (and optionally H2 stream 10) to sweep the permeate side of the membrane, the partial pressure of H2 on the permeate side is decreased thus increasing the partial pressure driving force for this separation. Almost all of the H2, preferably at least 90%, can be transferred from the effluent side to permeate side by using a membrane with a high enough selectivity for H2 over chlorosilanes. However, one of ordinary skill in the art will recognize that the invention may be performed such that as little as 50% of the H2 can be transferred from the effluent side to the permeate side. Additionally, depending upon the pressure of the feedstock tank 1, the resultant TCS and H₂ recycle 94 may be at a pressure sufficiently high enough that the recycle 94 need not be compressed by compressor 8 before being fed to feedstock tank 1. Alternatively, the degree of compression by compressor 8 of the recycle 94 may be reduced in comparison to conventional solutions not utilizing a TCS sweep gas. The phrase “recycle gas is directed to the polysilicon reactor” is not limited to methods whereby the recycle gas goes directly to the polysilicon reactor. Also, practice of the disclosed method is not limited to those whereby the recycle gas goes directly to the polysilicon reactor. Rather, it is within the scope of the disclosed method and claimed subject matter to include one or more intermediate vessels for containing the recycle gas or buffer vessels for buffering a flow of recycle gas to the reactor. One such vessel is the feedstock tank 1.

Since only the retentate flow from the gas separation unit 11 is fed to the purification system P, the reduced mass flow rate enables the use of smaller volume equipment and lowered energy requirements. Also, since the H2 permeation rate is much faster than any other species present in the effluent gas stream 9, the permeate stream has a negligible amount of undesirable impurities.

Suitable gas separation membranes include those chemically resistant to TCS, STC, H2, and HCl and which exhibit an enhanced permeance of H2 in comparison to the TCS, STC, and HCl. Such membranes can be configured in a variety of ways: sheet, tube, hollow fiber, etc.

Preferably, the gas separation membrane of gas separation unit 11 is a spiral flat sheet membrane or hollow fiber membrane made of a polymeric material such as a polysulfone, a polyether sulfone, a polyimide, a polyaramide, a polyamide-imide, and blends thereof.

One preferred type of hollow fiber membrane includes those disclosed by U.S. Published Patent Application 2006/0156920 A1, the contents of which are enclosed herein in their entirety. Those hollow polymeric fibers include polyimides, polyamides, polyamide-imides, and blends thereof. They include an outer selective layer.

The polyimide contains the repeating units as shown in the following formula (I):

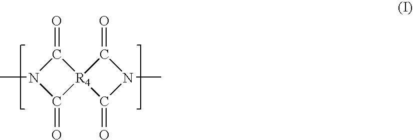

in which R₁ of formula (I) is a moiety having a composition selected from the group consisting of formula (A), formula (B), formula (C), and mixtures thereof, and

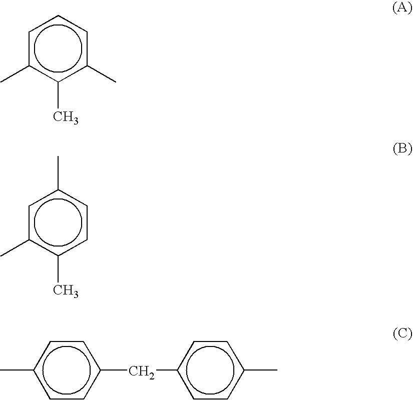

in which R₄ of formula (I) is a moiety having a composition selected from the group consisting of formula (Q), formula (S), formula (T) and mixtures thereof,

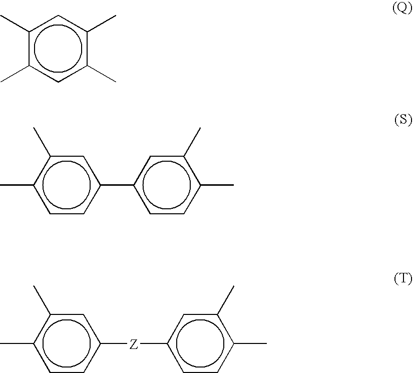

in which Z of formula (T) is a moiety selected from the group consisting of formula (L), formula (M), formula (N) and mixtures thereof.

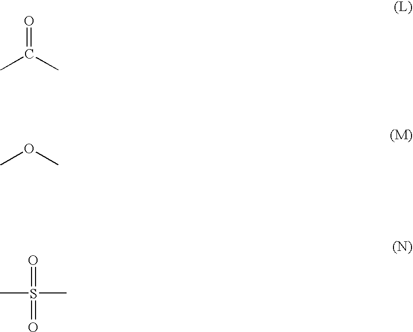

In one preferred embodiment, the polyimide component of the blend that forms the selective layer of the membrane has repeating units as shown in the following formula (Ia):

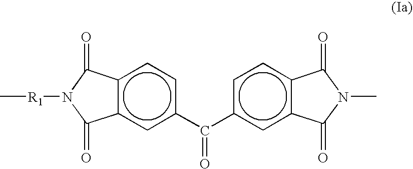

In this embodiment, moiety R₁ of formula (Ia) is of formula (A) in 0-100% of the repeating units, of formula (B) in 0-100% of the repeating units, and of formula (C) in a complementary amount totaling 100% of the repeating units. A polymer of this structure is available from HP Polymer GmbH under the trade name P84. P84 is believed to have repeating units according to formula (Ia) in which R₁ is formula (A) in about 16% of the repeating units, formula (B) in about 64% of the repeating units and formula (C) in about 20% of the repeating units. P84 is believed to be derived from the condensation reaction of benzophenone tetracarboxylic dianhydride (BTDA, 100 mole %), with a mixture of 2,4-toluene diisocyanate (2,4-TDI, 64 mole %), 2,6-toluene diisocyanate (2,6-TDI, 16 mole %) and 4,4′-methylene-bis(phenylisocyanate) (MDI, 20 mole %).

The polyimide (that is preferably formed in a known way to provide an outer selective layer) comprises repeating units of formula (Ib):

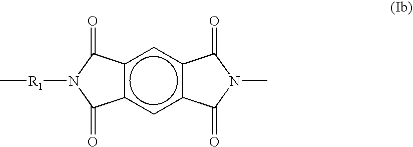

In one preferred embodiment, the polyimide is of formula (Ib) and R₁ of formula (Ib) is a composition of formula (A) in about 0-100% of the repeating units, and of formula (B) in a complementary amount totaling 100% of the repeating units.

In yet another embodiment, the polyimide is a copolymer comprising repeating units of both formula (Ia) and (Ib) in which units of formula (Ib) constitute about 1-99% of the total repeating units of formulas (Ia) and (Ib). A polymer of this structure is available from HP Polymer GmbH under the trade name P84HT. P84HT is believed to have repeating units according to formulas (Ia) and (Ib) in which the moiety R₁ is a composition of formula (A) in about 20% of the repeating units and of formula (B) in about 80% of the repeating units, and, in which repeating units of formula (Ib) constitute about 40% of the total of repeating units of formulas (Ia) and (Ib). P84HT is believed to be derived from the condensation reaction of benzophenone tetracarboxylic dianhydride (BTDA, 60 mole %) and pyromellitic dianhydride (PMDA, 40 mole %) with 2,4-toluene diisocyanate (2,4-TDI, 80 mole %) and 2,6-toluene diisocyanate (2,6-TDI, 20 mole %). The polyamide polymer of the blend that forms the selective layer of the membrane comprises the repeating units of the following formula (II):

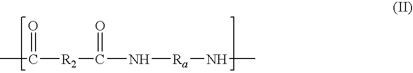

in which Rₐ is a moiety having a composition selected from the group consisting of formulas

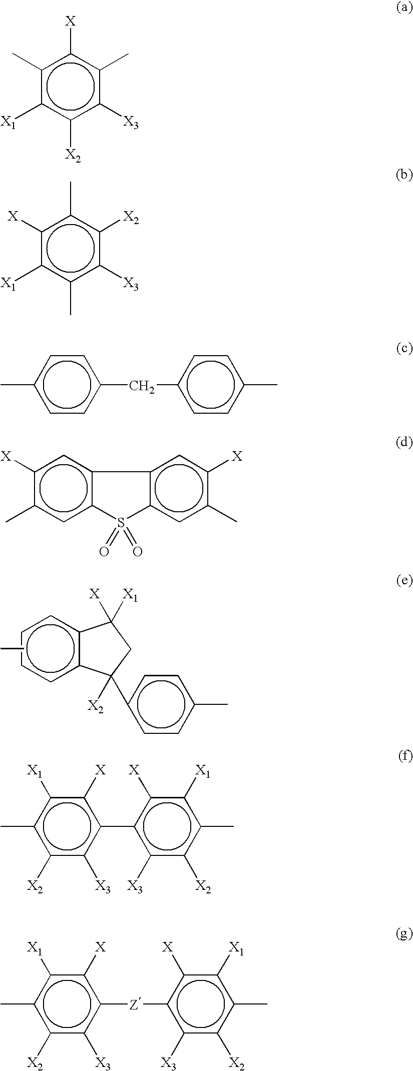

wherein Z′ of formula (g) is a moiety represented by the formula

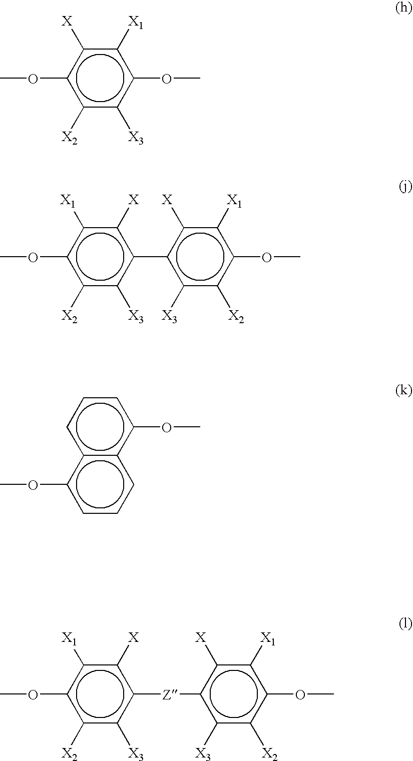

and mixtures thereof, and
in which X, X₁, X₂, and X₃ of formulas a, b, d, e, f, g, h, j, and, l independently are hydrogen or an alkyl group having 1 to 6 carbon atoms, and Z″ of formula (I) is selected from the group consisting of:

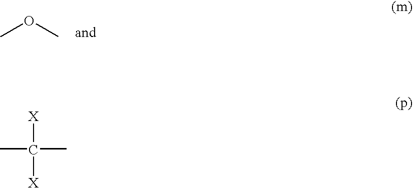

in which X of formula (p) is a moiety as described above.

R₂ of formula (II) is a moiety having a composition selected from the group consisting of formulas:

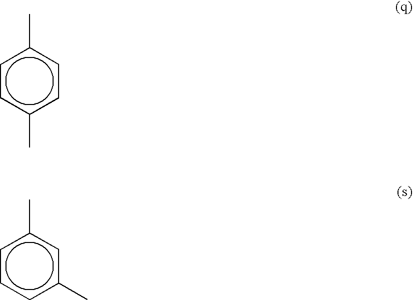

and mixtures thereof.

The polyamide-imide polymers of the blend that forms the selective layer of the membrane comprises the repeating units of formula (III); and/or a combination of the repeating units of formulas (I) and (II), (I) and (III), (II) and (III), and/or (I), (II), and (III).

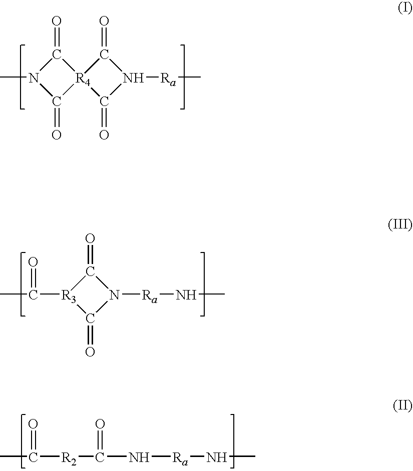

in which Rₐ, R₂, and R₄ are the same as described above, and

### R₃ is

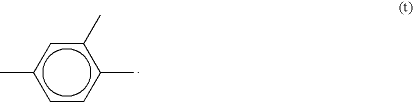

Membranes made from a blend of a polyimide or polyimides with a polyamide or polyamides, the ratio of polyimide to polyamide should preferably be at least 1:1, and more preferably, at least 2:1.

In the case of membranes made from a blend of a polyimide or polyimides with a polyamide-imide or polyamide-imides, the ratio of polyimide to polyamide-imide should preferably, be at least 1:1, and more preferably at least 2:1.

In the case of membranes made from a blend of a polyimide or polyimides with a polyamide or polyamides, and a polyamide-imide or polyamide-imides, the blend should preferably contain between 20-80% polyimide.

Surprising, the blends of this invention are homogeneous over a broad range of compositions. The miscibility of the blends of this invention may be confirmed by the presence of single compositional dependent glass transition temperature lying between those of the constituent blend components. The glass transition temperature can be measured by Differential Scanning Calorimetry or Dynamic Mechanical Analysis.

The polyimides described above are made by methods well known in the art. The polyimides can, for example, be conveniently made by polycondensation of an appropriate diisocyanate with approximately an equimolar amount of an appropriate dianhydride. Alternatively, the polyimides can be, for example, made by polycondensation of equimolar amounts of a dianhydride and a diamine to form a polyamic acid followed by chemical or thermal dehydration to form the polyimide. The diisocyanates, diamines, and dianhydrides useful for making the polyimides of interest are usually available commercially. The polyimides are typically prepared by the latter diamine process because the diamines are more readily available than the corresponding diisocyanates.

The polyamides described above can be made conveniently by polycondensation of an appropriate diamine or diamines with approximately an equimolar amount of an appropriate diacid chloride or mixtures of diacid chlorides by methods well known in the art.

The polyamide-imide polymers described above can be made conveniently by polycondensation of an appropriate diamine with approximately an equimolar amount of an appropriate triacid anhydride/chloride (i.e., repeating units of formula (III)).

In the case of a mixture of polyamide/polyamide-imides, the polyamide-imides described herein can be made conveniently by:
1) polycondensation of an appropriate diamine or diamines with an equimolar amount a mixture of dianhydride and diacid chloride mixture (i.e., repeating units of formulas (I) and (II));
2) by polycondensation of an appropriate diamine or diamines with an equimolar amount of a mixture of dianhydride and triacid anhydride chloride (i.e., repeating units of formulas (I) and (III));
3) by polycondensation of an appropriate diamine or diamines with an equimolar amount of a mixture of diacid-chloride and triacid anhydride/chloride (i.e., repeating units of formulas II and III); or
4) by polycondensation of an appropriate diamine or diamines with an equimolar amount of a mixture of dianhdride, diacid chloride, and triacid anhydride/chloride (i.e., repeating units of formulas I, II, and III).

The polyimides, polyamides, and polyamide-imides should be of suitable molecular weight to be film forming and pliable so as to be capable of being formed into continuous films or membranes. The polymers of this invention preferably have a weight average molecular weight within the range of about 20,000, to about 400,000, and more preferably, about 50,000 to about 300,000.

Another type of polymeric material particularly useful in the membrane includes an amorphous polymer of perfluoro-2,2-dimethyl-1,3-dioxole, as disclosed in U.S. Pat. No. 5,051,114, the contents of which are incorporated herein in their entirety. It may be a homopolymer of perfluoro-2,2-dimethyl-1,3-dioxole. It may instead be a copolymer of perfluoro-2,2-dimethyl-1,3-dioxole, including copolymers having a complementary amount of at least one monomer selected from the group consisting of tetrafluoroethylene, perfluoromethyl vinyl ether, vinylidene fluoride and chlorotrifluoroethylene. Preferably, the polymer is a dipolymer of perfluoro-2,2-dimethyl-1,3-dioxole and a complementary amount of tetrafluoroethylene, especially such a polymer containing 65-99 mole % of perfluoro-2,2-dimethyl-1,3-dioxole. The amorphous polymer preferably has a glass transition temperature of at least 140.degree. C., and more preferably at least 180.degree. C. Examples of dipolymers are described in further detail in U.S. Pat. No. 4,754,009, the contents of which are incorporated herein in their entirety.

Another type of polymeric material particularly useful in the membrane includes a polymer available under the trade name MATRIMID 5218, a polymer available under the trade name ULTEM 1000, and blends thereof as disclosed in U.S. Pat. No. 5,248,319. MATRIMID 5218 is the polymeric condensation product of 3,3′,4,4′-benzophenone tetracarboxylic dianhydride and 5(6)-amino-1-(4′-aminophenyl)-1,3,3′-trimethylindane, commercially available from Ciba Specialty Chemicals Corp. Ultem 1000 may be obtained from a wide variety of commercial sources, including Polymer Plastics Corp. located in Reno, Nev. and Modern Plastics located in Bridgeport, Conn. Ultem 1000 has the formula shown below.

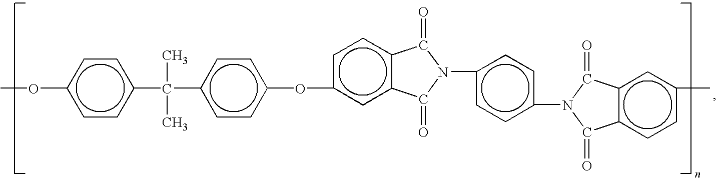

The membranes of the invention typically have continuous channels for fluid flow extending between the exterior and interior surfaces. These pores have an average cross-sectional diameter less than about 20,000 Angstroms, preferably less than about 1,000 or 5,000 Angstroms. The hollow fibers may have outside diameters of about 20 to 1,000 microns, generally about 50 to 1,000 microns, and have walls of at least about 5 microns in thickness, generally about 50 to about 1,000 microns thick. The wall thickness in some hollow fibers may be up to about 200 or 300 microns. The coating may have a thickness ranging from about 0.01 to about 10 microns and preferably has a thickness of about 0.05 to about 2 microns.

In the case of hollow fiber membranes, in order to provide desirable fluxes through the hollow fibers, particularly using those hollow fibers having walls at least about 50 microns in thickness, the hollow fibers may have a substantial void volume. Voids are regions within the walls of the hollow fibers which are vacant of the material of the hollow fibers. Thus, when voids are present, the density of the hollow fiber is less than the density of the bulk material of the hollow fiber. Often, when voids are desired, the void volume of the hollow fibers is up to about 90, generally about 10 to 80, and sometimes about 20 or 30 to 70, percent based on the superficial volume, i.e., the volume contained within the gross dimensions, of the hollow fiber or flat sheet.

The density of the hollow fiber can be essentially the same throughout its thickness, i.e., isotropic, but the hollow fiber is preferably characterized by having at least one relatively dense region within its thickness in barrier relationship to fluid flow through the wall of the hollow fiber, i.e., the hollow fiber is anisotropic.

One of ordinary skill in the art will recognize that well known system parameters such as the number of fibers can be adjusted such that recycle 94 leaving the permeate side of the membrane has a composition suitable for the deposition reactor.

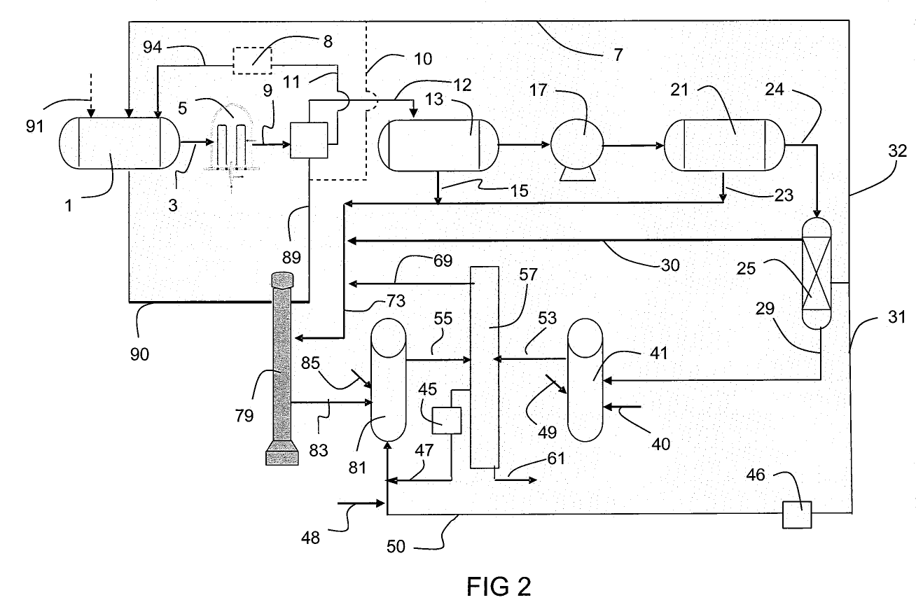

As best illustrated in FIG. 2, in another embodiment further details regarding the TCS purification are described. TCS and H2 feed 3 from feedstock tank 1 are fed to polysilicon reactor 5 where they react according to the below reactions:

SiHCl₃+H₂→Si+3HCl

The following equilibrium reactions also play a role:

2 SiHCl₃←→Si+SiCl₄+2HCl (1050-1200° C.)

4 SiHCl₃←→3SiCl₄+2H₂+Si

SiHCl₃+HCl←→SiCl₄+H₂

TCS is also in equilibrium with SiCl₂, a key intermediate:

SiHCl₃←→SiCl₂+HCl

While the schematic crudely depicts a bell jar shape, the invention is equally applicable to Siemens-type bell jar reactors and fluidized bed reactors. A wall temperature of the reactor is maintained at a temperature of about 575° C. and a deposition temperature is maintained at a temperature of about 1100° C. One of ordinary skill in the art will recognize that the TCS and H2 need not be fed to reactor 5 from a feedstock tank 1. Rather, each of the reactants may be fed directly to reactor 5 without the intermediary feedstock tank 1. Because the ratio of TCS to H2 in recycle 94 may not be equivalent to the stoichiometric ratio desired for the reactor 5, one may optionally supplement the TCS and H2 in feedstock tank 1 with optional make up TCS and optional make up H2 91.

Effluent gas stream 9 containing silicon tetrachloride (STC), an amount of non-reacted TCS, HCl, and H2 is directed to gas separation membrane 11 where it is separated into a H₂-rich stream typically containing about 93% by volume H2 and a H₂-lean stream 12 containing TCS, STC, HCl, and a minor amount of H2.

H2-lean stream 12 is condensed at a temperature of about −40° C. and −60° C. in two stages at condensers 13, 21, respectively, with intermediate compression at compressor 17 to a pressure of about 153 psig. The condensates 15, 23 contain mixtures of TCS, STC, and dissolved HCl while the vapor component 24 contains a mixture of TCS, STC, HCl, and H₂.

The vapor component 24 is directed to an adsorption unit 25 which is a thermal swing adsorbent (TSA) unit operated to separately recover H2, HCl, and chlorosilanes (TCS and STC). The H₂ portion freely passes through the adsorbent and is divided into two streams 31, 32. Stream 31 is directed towards compressor 46 for eventual feeding to TCS reactors 41, 81, while stream 32 is directed towards feedstock tank 1. The recovered HCl portion is directed to TCS reactor 41 via stream 29. The recovered TCS/STC portion is directed to distillation unit 79 via stream 30.

Again referring to FIG. 2, HCl stream 29, and optional make-up HCl stream 40 are fed to TCS reactor 41 along with metallurgical grade Silicon (MG Si) feed 49. The following reaction takes place at TCS reactor 41 (fluidized bed):

Si+3HCl→SiHCl₃+H2

Typically silicon powder ground to an average particle size of about 100-200 μm is fed continuously with hot nitrogen to the reactor 41, where the reaction takes place at about 50 psig and 300° C.

TCS product stream 53 and TCS/STC product stream 55 are fed to purification unit 57 where a chlorosilane wash is utilized to condense out any gaseous TCS and STC from stream 55 as well as remove any undesired solid impurities in waste stream 61. TCS stream 73 comprising TCS/STC stream 69 from purification unit 57, and condensates 15, 23 from condensers 13, 21 are fed to distillation unit 79. The distillation unit 79 may comprise one or more distillation columns. Residual H2 is compressed at compressor 45 to provide make-up H2 47.

STC feed 83 and MG Si feed 85 are fed to TCS reactor 81 along with make-up H2 47. The following reaction takes place at TCS reactor 81 in the presence of a CuCl catalyst:

Si+3 SiCl4+2H2→4 SiHCl₃

Typically, the reactor 81 is maintained at a pressure and temperature of about 500 psig and 500° C.

TCS product stream 53 and TCS/STC product stream 55 are fed to purification unit 57 where a chlorosilane wash is utilized to condense out any gaseous TCS and STC from stream 55 as well as remove any undesired solid impurities in waste stream 61. TCS stream 73 comprising TCS/STC stream 69 from purification unit 57, TCS and STC stream 30, and condensates 15, 23 from condensers 13, 21 are fed to distillation unit 79. The distillation unit 79 may comprise one or more distillation columns. Again, residual H2 is compressed at compressor 45 to provide make-up H2 47. Also, supplemental make-up H2 stream 50 comes from compressor 46. An optional supplemental make-up H2 stream 48 may also be supplied.

Purified TCS stream 89 is fed to the permeate “side” of the membrane where it acts as a sweep gas to lower the partial pressure of H2 permeating through the membrane from the effluent gas 9. One of ordinary skill in the art will recognize that the permeate “side” of a membrane does not necessarily mean one and only one side of a membrane. Rather, in the case of membranes include a plurality of hollow fibers, the permeate “side” actually is considered to be the plurality of sides of the individual hollow fibers that are opposite to the sides to which the effluent gas 9 is introduced.

Optionally and in order to reduce the tendency of TCS in stream 89 to condense, H2 stream 10 may be added to stream 89 to lessen such tendency. Also, one of ordinary skill in the art will recognize that any portion of purified TCS not directed to gas separation unit 11 may be directed to feedstock tank 1 instead. Thus, the combined TCS (and optional stream 10 H2) sweep gas and H2-rich stream comprise the TCS/H2 recycle 94.

Using TCS stream 89 (and optional H2 stream 10) on the permeate side of the membrane maintains a high driving force for recovering H2. Because of this, TCS can be fed at high pressure without sacrificing the separation. In one example case simulated using membrane simulation tool, a TCS sweep gas could be operated at 45 psig while recovering >90% of hydrogen. In practical terms, the sweep stream pressure can even be higher, even up to feed pressure of effluent stream. The only drawback of such a high pressure would be the increased permeation of HCl. This can be, however, fixed by choosing operating conditions/membrane such that a high H₂/HCl selectivity could be obtained. Also, if the pressure of the recycle 94 is lower than that of the feedstock tank 1, an optional compressor 8 may be used to boost its pressure to the desired level.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method for recycling effluent gas from a polysilicon production reactor, comprising the steps of:
directing an effluent gas from a polysilicon reactor to a gas separation unit comprising at least one gas separation membrane, said effluent gas comprising SiHCl₃, SiCl₄, HCl, and H₂;
directing a sweep gas comprising high purity SiHCl₃ to a permeate side of the membrane;
recovering a recycle gas from the permeate side, the recycle gas comprising H₂ permeated through the membrane from the effluent gas and SiHCl₃ from the sweep gas; and
directing the recycle gas to the polysilicon reactor.

2. The method of claim 1, further comprising the steps of:
recovering a retentate gas from the gas separation unit, the retentate gas comprising SiHCl₃, SiCl₄, HCl, and H₂;
directing the retentate gas to a SiHCl3 production process; and
obtaining purified SiHCl3 from the SiHCl3 production process, wherein the sweep gas comprises at least a portion of the obtained purified SiHCl3.

3. The method of claim 1, wherein the recycle gas is not compressed before being directed to the polysilicon reactor.

4. The method of claim 1, wherein the effluent gas is not compressed before being directed to the gas separation unit.

5. The method of claim 1, wherein at least 50% of H2 in the effluent gas permeates to the permeate side.

6. The method of claim 1, wherein at least 90% of H2 in the effluent gas permeates to the permeate side.

7. The method of claim 2, wherein said SiHCl3 production process comprises the steps of:
chilling the retentate gas to produce a first condensate and a first non-condensate, the first condensate comprising predominantly SiHCl3 and SiCl4, the first non-condensate comprising a major amount of H2, a minor amount of chlorosilanes comprising SiHCl3, SiCl4, and a minor amount of HCl;
directing the first non-condensate to an adsorption unit wherein the major amount of H2 is stripped and the minor amount of HCl is separated from the minor amount of chlorosilanes;
directing the first condensate and the chlorosilanes to a distillation unit comprising at least one distillation column; and
producing the purified SiHCl3 at the distillation unit.

8. The method of claim 7, wherein said SiHCl3 production process further comprises the steps of:
feeding Si and the HCl separated from the chlorosilanes to a first SiHCl3 reactor thereby producing impure SiHCl3;
purifying the impure SiHCl3 at a purification unit to produce a SiHCl3 feed;
directing the SiHCl3 feed to the distillation unit.

9. The method of claim 8, wherein said SiHCl3 production process further comprises the steps of:
feeding SiCl4 from the distillation unit, Si, and H2 to a second SiHCl3 reactor in the presence of CuCl thereby producing impure SiHCl3; and
purifying the impure SiHCl3 from the second SiHCl3 reactor at purification unit.

10. A system for recycling effluent gas from a polysilicon production reactor, comprising:
a gas separation unit comprising at least one gas separation membrane, an inlet, a permeate outlet, and a retentate outlet, the inlet being adapted and configured to fluidly communicate with an effluent gas outlet of a polysilicon reactor, the permeate outlet being adapted and configured to fluidly communicate with a reactant feed inlet of the polysilicon reactor; and
a SiHCl3 production unit adapted and configured to produce purified SiHCl3 comprising an inlet in fluid communication with the retentate outlet and an outlet in fluid communication with a permeate side of the membrane.

11. The system of claim 10, wherein the membrane has a higher permeability to H2 than SiHCl3, HCl, and SiCl4.

12. The system of claim 10, wherein there is no compressor in between the permeate outlet and the reactant feed inlet.

13. The system of claim 10, wherein there is no compressor in between the effluent gas outlet and the membrane inlet.

14. The system of claim 10, further comprising:
a first condensation unit having an inlet, a condensate outlet, and a vapor outlet, the condensation inlet being in fluid communication with the retentate outlet;
an adsorption unit adapted and configured to strip H2 from a SiCl4, SiHCl3, HCl, and H2 containing vapor from the vapor outlet of the condensation unit and separate the remaining SiCl4, SiHCl3, and HCl into HCl and chlorosilanes comprising the remaining SiCl4 and SiHCl3; and
a distillation unit having inlets in fluid communication with the first condensation unit outlet and the adsorption unit and having a purified SiHCl3 outlet in fluid communication with the inlet of the membrane.

15. The system of claim 14, wherein the first condensation unit comprises first and second condensers connected in series and separated by a compressor.

16. The system of claim 14, further comprising:
a first SiHCl3 reactor having reactant inlets in fluid communication with a source of Si and the adsorption unit; and
a purification unit having an inlet and outlet, the purification unit inlet being in fluid communication with an outlet of the first SiHCl3 reactor, the purification unit inlet being adapted and configured to receive impure SiHCl3 from the first SiHCl3 reactor, the purification unit outlet being in fluid communication with an inlet of the distillation unit.
